(19) United States
(12) Patent Application Publication
(10) Pub. No.: US 2005/0003235 A1
(43) Pub. Date: Jan. 6, 2005

(54) Process of producing magnetic recording medium

(75) Inventor: Kouichi Masaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/879,618

(22) Filed: Jun. 30, 2004

(30) Foreign Application Priority Data
Jul. 2, 2003 (JP) 2003-270381

(51) Int. Cl. G11B 5/68

(52) U.S. Cl. 428/694 BR; 428/328; 428/329; 428/336; 428/694 BN; 428/694 BH

(57) ABSTRACT

A process for producing a magnetic recording medium comprising the steps of applying a coating composition containing non-magnetic powder and a binder on a support to form a non-magnetic layer having a thickness of 0.5 to 2.5 μm, a specific surface area of 20 to 120 m²/ml, a pore volume of 0.15 to 0.40 ml/ml, and a mean pore radius of 3 to 16 nm and applying a coating composition containing ferromagnetic powder and a binder on the non-magnetic layer to form a magnetic layer having a thickness of 25 to 150 nm.

### FIELD OF THE INVENTION

This invention relates to a process of producing a magnetic recording medium for high density recording which has a magnetic layer and a substantially non-magnetic intermediate layer and contains ferromagnetic powder in the uppermost magnetic layer. More particularly, it relates to a process of producing a magnetic recording medium having a high S/N ratio when reproduced with a magnetoresistive (MR) head.

### BACKGROUND OF THE INVENTION

Magnetic recording technology has been widely used in various applications, including video and computer data recording, because of its superior advantages over other recording systems, such as repeated usability of recording media, ease of signal digitalization, capability of system construction with peripheral equipment, and ease of signal correction.

To cope with the trends to smaller equipment, higher quality of reproduced signals, longer recording time, and increased recording capacity, there has always been a demand for recording media to have further improved recording density, reliability and durability.

For example, in view of practical application of digital recording technology promising improved sound and image qualities and development of recording technology applicable to high-definition broadcast, a magnetic recording medium that is writable and readable (capable of being reproduced) at shorter wavelengths than in conventional systems and exhibits high reliability and durability even at an increased relative running speed with respect to a head has now come to be demanded. Also in computer applications, a high-capacity digital recording medium has been awaited so as to store an ever increasing amount of data to be archived. In magnetic disk applications, too, the recent rapid increase of volume of data to be dealt with has boosted the demand for a high-capacity floppy disk. In the field of high-capacity floppy disks containing ferromagnetic metal powder excellent in high-density recording characteristics, 100 MB or larger HDFDs (high-density flexible disks) are now available, but a system enabling still larger capacity and higher transfer rates is needed.

For the purpose of increasing the recording density on a magnetic recording medium, the wavelength of signals to be used has been getting shorter and shorter. As the recording wave length approaches a comparable size to the magnetic particle size, a clear transition state cannot be created, resulting in a substantial failure of recording. Therefore, it is required to develop magnet particles sufficiently small in relation to the shortest wavelength used for high-density recording. From this aspect, the size of magnetic particles has continued to become smaller and smaller in response to market demands for higher recording capacity.

Magnetic tapes used in a digital signal recording system usually has a 2.0 to 3.0 μm thick single-layered magnetic coating containing ferromagnetic powder, a binder, and an abrasive on one side of a non-magnetic support and a backcoating on the other side for preventing winding disturbance and maintaining running durability. Such a relatively thick single magnetic layer suffers from self demagnetization loss in writing and output reduction due to thickness loss in reproducing.

To reduce the magnetic layer thickness is known effective to minimize reproduce output reduction due to the thickness loss. For example, JP-A-5-182178 discloses a magnetic recording medium comprising a non-magnetic support having formed thereon a non-magnetic lower layer containing inorganic powder dispersed in a binder and an upper magnetic layer containing ferromagnetic powder dispersed in a binder. The upper magnetic layer is applied to a dry thickness of 1.0 μm or smaller while the lower non-magnetic layer is wet.

A magnetic recording medium should have an increased S/N ratio in order to achieve downsizing of equipment, to improve reproduce signal quality, to increase recording time, and to increase recording capacity. A magnetic recording medium having, on its non-magnetic support, at least two layers including a non-magnetic layer containing non-magnetic powder and a binder and a magnetic layer containing ferromagnetic powder and a binder shows, in principle, reduced self demagnetization and has a reduced surface roughness (reduced spacing loss) and therefore exhibits high performance. Nevertheless, it has turned out that the uniformity of the non-magnetic layer/magnetic layer interface is of importance for obtaining an improved areal recording density. JP-A-5-73883 proposes a magnetic recording medium of which the magnetic layer has a thickness d of 1 μm or smaller and an average thickness variation Δd of d/2 or smaller. JP-A-5-298654 discloses a magnetic recording medium of which the magnetic layer has a thickness d of 0.01 to 0.3 μm and a standard deviation a of thickness satisfying the relationship: 0.05≦σ/d≦0.5. However, because there is an effective recording depth which is estimated to be a quarter of the recording wavelength in short-wavelength recording, thickness reduction of a magnetic layer for increasing recording density results in disturbances of the interface between the non-magnetic layer and the magnetic layer, which causes noise.

A magnetoresistive effect head (MR head) with high sensitivity has recently been extending its use in computer data recording systems, which has pushed development of a recording system securing a high S/N ratio. In this system, a system noise is governed by the noise caused by a magnetic recording medium. That is, it is essentially required for a recording medium applied to a system using an MR head to have a reduced noise. The recording medium is also required to have both running durability and a moderate head cleaning effect. In order to secure a high S/N ratio and satisfactory running durability, proposals have been made with reference to the pore volume of a magnetic recording medium and migration of a lubricant as described in JP-A-2-260219, JP-A-2-260220, JP-A-2002-140808, JP-A-2002-208130, JP-A-2003-30813, JP-A-10-302245, and JP-A-11-175949.

### SUMMARY OF THE INVENTION

An object of the present invention is to provide a process for producing a magnetic recording medium which does not invite saturation of an MR head, achieves an increased S/N ratio particularly owing to reduced interfacial disturbances and improved surface properties, and has a reduced error rate.

The present inventors have investigated magnetic characteristics and magnetic layer thickness necessary for averting saturation of an MR head. They have also studied on how to minimize interfacial disturbances between a magnetic layer and a non-magnetic layer and to reduce the surface roughness of a magnetic recording medium. As a result, they have found that a magnetic recording medium whose magnetic layer is as thin as 25 to 150 nm and yet smooth on its surface can be produced by a specific process described below. The inventors have ascertained that the process they propose provides a magnetic recording medium which does not invite saturation of an MR head, achieves an increased S/N ratio particularly owing to reduced medium noise, and has a reduced error rate.

The present invention provides a process of producing a magnetic recording medium comprising the steps of applying a coating composition containing non-magnetic powder and a binder on a support to form a non-magnetic layer having a thickness of 0.5 to 2.5 μm, a specific surface area of 20 to 120 m²/ml, a pore volume of 0.15 to 0.40 ml/ml, and a mean pore radius of 3 to 16 nm and applying a coating composition containing ferromagnetic powder and a binder on the non-magnetic layer to form a magnetic layer having a thickness of 25 to 150 nm.

In a preferred embodiment of the process, the ferromagnetic powder is a ferromagnetic metal powder having an average long axis length of 30 to 65 nm, a coefficient of long axis length variation of 0 to 35%, an average aspect ratio of 3.5 to 7.5, a coercive force of 143 to 223 kA/m, a saturation magnetization of 85 to 125 A.m²/kg, and a specific surface area of 45 to 120 m²/g.

In another preferred embodiment of the process, the ferromagnetic powder is a hexagonal ferrite powder having an average diameter of 15 to 35 nm, a coefficient of diameter or thickness variation of 0 to 30%, an average aspect ratio of 1.5 to 4.5, a coercive force of 120 to 320 kA/m, a saturation magnetization of 40 to 55 A.m²/kg, and a specific surface area of 40 to 100 m²/g.

According to the process of the invention, a non-magnetic layer and a magnetic layer are formed by a wet-on-dry coating technique, and the non-magnetic layer is characterized in terms of thickness, specific surface area, pore volume, and mean pore radius. By this process, there is obtained a magnetic recording medium in which the magnetic layer is very thin and yet has an ultrasmooth surface with reduced disturbances in its interface with the underlying non-magnetic layer. In particular, where ultrafine magnetic powder having high output, excellent dispersibility, and high durability is used in the thin magnetic layer, self demagnetization loss is reduced, and the output in the high frequency region is secured to decrease the noise in the full range. Overwrite performance is also improved. The effects of the thin magnetic layer are maximized in applications to a system using an MR element or a giant MR element as a reproducing head. That is, the magnetic recording medium exhibits improved high-density digital recording performance and superior running durability.

### DETAILED DESCRIPTION OF THE INVENTION

The process of the present invention makes it possible to produce a magnetic recording medium fit for an MR head system that has never been attained by conventional technologies.

The gist of the present invention resides in the finding that ultrasmoothness of the thin magnetic layer and reduction of interfacial disturbances between the magnetic layer and the non-magnetic (lower) layer can be achieved by specifying the ranges of the thickness, specific surface area, pore volume, and mean pore radius of the non-magnetic layer. The present invention is supported by fundamental techniques including increased coercivity of magnetic powder to be used in the magnetic layer and ultrafineness, improved particle size distribution, and improved dispersibility of magnetic and non-magnetic powders. These fundamental techniques are synthesized and combined with the above finding to complete the present invention.

The magnetic recording medium produced by the process of the invention contains ultrafine magnetic powder excellent in output, dispersibility and durability in the ultrathin magnetic layer and spherical, needle-like or other-shaped inorganic powder in the lower layer. By reducing the magnetic layer thickness with optimized magnetization, the self demagnetization in the magnetic layer can be reduced, the output in the high frequency region can be secured thereby to reduce the noise in the full range, and, in addition, overwrite characteristics can be improved. Improvements on reproducing and writing heads would make the ultrathin magnetic layer exert more effect and bring about further improvement in digital recording performance. The magnetic recording medium obtained by the process of the invention is especially suited in systems using an MR element or a giant MR element as a reproducing head.

Noise of particulate magnetic recording media is caused by many factors, such as the size of magnetic particles, defects of the magnetic layer (e.g., surface roughness, voids, agglomeration of magnetic powder, disturbances in the interface with the lower layer, thickness variation, and distributions of various physical properties), and the degree of interaction between magnetic particles in the magnetic layer. The present inventors have investigated into the degrees of contribution of these factors to noise. They have ascertained as a result that the thickness, specific surface area, pore volume, and mean pore radius of the non-magnetic layer that is formed before formation of the magnetic layer exert great influences on the magnetic layer surface roughness, the magnetic powder agglomeration, the interfacial disturbances between the magnetic and the non-magnetic layers, and the like. They have found accordingly that a magnetic recording medium satisfying a high S/N ratio and running durability can be produced by specifying these physical attributes and completed the present invention.

The process of the invention basically includes the step of forming a magnetic layer on a non-magnetic layer that has previously been formed by applying a coating composition containing non-magnetic powder and a binder.

To begin with, the characteristics that are specified in the invention with respect to the non-magnetic layer are described.

The thickness of the non-magnetic layer is 0.5 to 2.5 μm, preferably 0.6 to 2.5 μm, still preferably 0.7 to 2.5 μm.

With the non-magnetic layer thickness falling within the above range, the following effects are exerted. The non-magnetic layer has adequate capability of holding a sufficient amount of a lubricant to secure running durability. An adequate pore volume is secured, and the solvent of a coating composition for a magnetic layer is prevented from selectively penetrating the non-magnetic layer. Therefore, dissolution of the non-magnetic layer is suppressed to reduce the surface roughness, which leads to reduction of surface roughness of the upper magnetic layer.

The specific surface area of the non-magnetic layer is 20 to 120 m²/ml, preferably 20 to 110 m²/ml, still preferably 20 to 100 m²/ml.

The pore volume of the non-magnetic layer is 0.15 to 0.40 ml/ml, preferably 0.16 to 0.39 ml/ml, still preferably 0.17 to 0.39 ml/ml.

The mean pore radius of the non-magnetic layer is 3 to 16 nm, preferably 4 to 16 nm, still preferably 5 to 15 nm.

With the specific surface area, pore volume and mean pore radius falling within the above-recited respective ranges, the solvent of the coating composition for a magnetic layer is prevented from selectively penetrating the non-magnetic layer. Therefore, dissolution of the non-magnetic layer is suppressed to reduce the surface roughness, which leads to reduction of surface roughness of the upper magnetic layer. Furthermore, the non-magnetic layer satisfying these properties exhibits necessary adhesion to a base film support and, where calendered, shows good calenderability to further reduce the surface roughness of the magnetic layer.

A non-magnetic layer satisfying the conditions of specific surface area, pore volume, and mean pore radius can be formed by, for example, (1) selecting the size and specific surface area of the powder used in the non-magnetic layer, (2) controlling the amount of the binder used in the non-magnetic layer, or (3) selecting the size, specific surface area, amount and the like of conductive particles used in the non-magnetic layer.

The specific surface area, pore volume, and mean pore radius as referred to in the present invention are those measured by nitrogen adsorption. Measurements are made as follows. A non-magnetic layer is formed on a support to prepare a sample, and a specimen with an area of 300 to 600 cm² is cut out. The specimen is measured for weight and coating thickness. Nitrogen adsorption/desorption isotherms are measured with an automatic gas adsorption analyzer AUTOSORB-1 from Quanta Chrome Inst. Co. at liquid-nitrogen temperature. Prior to the measurements, all the specimens must be degassed at room temperature for 5 hours. The specific surface area per unit weight is calculated from the data according to multipoint BET method. The isotherms are analyzed by the BJH method to obtain the pore size distribution, from which the pore volume per unit weight and the mean pore radius are calculated. The specific surface area per unit weight and the pore volume per unit weight are converted to those per unit volume (ml). The volume of the non-magnetic layer is obtained from the area and thickness of the non-magnetic layer.

Cumulative curves of pore distribution in nitrogen absorption/desorption give D10 and D90 data. D10 and D90 are the pore radii at which the cumulative pore volume is 10% and 90%, respectively, of the total pore volume. The term “mean pore radius” as used herein corresponds to D50 at which the cumulative pore volume is 50% of the total pore volume.

The thickness of the magnetic layer (upper layer) is decided so as to have a predetermined Br-δ (Br: residual magnetic flux density; δ: magnetic layer thickness) in order to avoid saturation of a high sensitivity MR head. The magnetic layer preferably has a saturation magnetic flux density of 100 to 400 mT and a Br.δ of 0.5 to 40 mT.μm, still preferably 1.0 to 40 mT.μm. For reducing transition noise and enhancing resolution, the magnetic layer preferably has a thickness of 25 to 150 nm, still preferably 25 to 100 nm. Formation of such an ultrathin magnetic layer with a uniform thickness can be accomplished by coating with a magnetic coating composition prepared by finely dispersing fine ferromagnetic particles and, if needed, fine non-magnetic particles in a binder having high dispersing capability with the aid of a dispersant.

The magnetic layer preferably has a coercive force (Hc) of 125 kA/m or higher, still preferably 143 kA/m or higher, particularly preferably 159 to 278 kA/m. While not explicit, it is considered that the upper limit of the coercive force will be raised with an improvement on a recording head. The high recording density as aimed at in the present invention is attained when the magnetic layer has a coercive force of at least 125 kA/m. It is desirable to optimize the coercive force, thickness, and Br.δ of the magnetic layer in accordance with the particular head used in the system to which the magnetic recording medium is applied.

The three dimensional mean surface roughness (Sa) of the magnetic layer is preferably 3.0 nm or smaller, still preferably 2.7 nm or smaller, particularly preferably 2.5 nm or smaller. The lower limit of Sa is not critical provided that the running durability is secured. It is usually about 0.5 nm. With the Sa being 3.0 nm or smaller, the head-to-medium spacing loss is minimized, and the magnetic recording medium is allowed to exhibit high output and low noise performance effectively.

Durability is a significant factor of a magnetic recording medium particularly where the running speed of a medium relative to a head should be increased to obtain a higher transfer rate. In magnetic tape applications, a helical scan system needs a head's rotational speed 1.5 to 10 or even more times higher than in conventional recording systems. Even in a linear recording system, it is necessary to increase the tape running speed. In magnetic disk applications, durability of a magnetic recording medium is an important subject because a magnetic head, components in a cartridge, and a recording medium slide at a high speed. Means for improving magnetic recording medium's durability include a binder formulation for increasing coating film strength and a lubricant formulation for assuring slip on a magnetic head.

In the process of the invention, what we call “3D network binder system” is adapted to secure running stability and durability at high rotation speeds and high transfer rates.

As for the lubricant formulation, a plurality of lubricants exhibiting excellent effects under different ranges of environmental condition are used in combination so as to stably serve as a whole under a broad environmental range of from low to high temperatures and from low to high humidities.

The dual layer structure can also be taken advantage of for improving the running durability. The non-magnetic layer acts as a lubricant reservoir that continuously feeds an adequate amount of a lubricant to the upper magnetic layer. Because the amount of a lubricant that can be incorporated into an ultrathin magnetic layer is limited, a reduction in magnetic layer thickness results in a reduction in absolute amount of the lubricant present in the layer, making it difficult to secure running durability. In the dual layer structure, the upper and lower layers are designed to perform their respective functions complemented by each other thereby to bring about improvements on both electromagnetic conversion and durability. This sharing of function is particularly effective in a system where a magnetic head and a medium slide at a high relative surface speed.

The lower layer can serve for not only feeding a lubricant but also controlling surface resistivity. It is a generally followed practice to add a solid conductive material such as carbon black to a magnetic layer for electric resistance control. Addition of such a conductive material restricts of necessity the magnetic powder packing density and also adversely affects the surface roughness of such an ultrathin magnetic layer. Hence, incorporation of a conductive material into the lower layer eliminates these disadvantages. Moreover, the lower layer produces a cushioning effect that improves the head touch and stabilizes the running properties.

The recording track density increases with increase in magnetic recording capacity and/or density. In general, a servo recording area is provided on a medium to ensure traceability of a magnetic head for a recording track.

The magnetic recording material is expected to have an improved linear recording density and an improved track density, which understandably brings about an increased recording density. The track traceability can further be stabilized by using a support with enhanced isotropic dimensional stability, and the surface smoothness of the magnetic layer can further be improved by use of a support with an ultrasmooth surface. The magnetic layer and the backcoating layer of the magnetic recording material produced by the process of the invention also have dimensional stability against temperature or humidity change.

The need for image recording has been intensified by the spread of multimedia systems for personal as well as industrial uses. The large capacity magnetic recording medium of the present invention is capable of fulfilling the demands for function and cost as a medium for storing not only text data but image data. The large capacity magnetic recording medium of the invention, being based on the time-proven particulate magnetic recording media, exhibits high reliability in long term use and boasts high cost performance.

The aforementioned various factors are accumulated and synthesized to produce interactions synergistically and organically in applications to magnetic recording systems.

The ferromagnetic powder that can be used in the invention includes ferromagnetic metal powder and hexagonal ferrite powder. The ferromagnetic metal (inclusive of alloy) powder is not particularly limited as long as it contains α-Fe as a main ingredient. The ferromagnetic metal powder may contain other elements in addition to α-Fe, such as Al, Si, S, Ca, Ti, V, Cr, Cu, Y, Mo, Rh, Pd, Ag, Sn, Ba, Ta, W, Au, Bi, La, Ce, Pr, Nd, P, Co, Mn, Zn, Ni, Sr, and B. Those doped with at least one of Al, Si, Ca, Y, Ba, La, Nd, Co, Ni, and B, particularly at least one of Co, Al, Y, and Nd, are preferred. Still preferred are those containing 10 to 50 atom % of Co, 2 to 20 atom % of Al, and 3 to 20 atom % of Y and/or Nd.

It is preferred for the ferromagnetic metal powder for use in the invention to assure high output and to have high dispersibility and improved orientation so as to maximize its performance in a high density region. Specifically, ultrafine ferromagnetic metal powder assuring high output, particularly one having an average long axis length of 30 to 65 nm, a crystallite size of 80 to 140 Angstrom, and a relatively high cobalt content, and containing an aluminum or yttrium compound as an anti-sintering agent is preferably used to assure high output and high durability. It is also important for the ferromagnetic metal powder to have excellent size distribution, i.e., a coefficient of long axis length variation (standard deviation of long axis length/mean long axis length) of 0 to 30%. The ferromagnetic metal powder preferably has an average aspect ratio of 3.5 to 7.5, a coercive force of 143 to 223 kA/m, a saturation magnetization of 85 to 125 A.m²/kg, and a BET specific surface area (S_{BET}) of 45 to 120 m²/g. A ferromagnetic metal power with these preferred characteristics is obtainable through the techniques or a combination of the techniques proposed in JP-A-9-22522, JP-A-9-106535, JP-A-6-340426, and JP-A-11-100213.

In order to accomplish high density recording, it is preferred for the ferromagnetic powder to have high coercivity. While varying according to the recording head used, a preferred coercive force ranges 143 to 223 kA/m. An increase of coercivity poses an overwrite problem. Since the coercivity of ferromagnetic metal powder primarily depends on anisotropy in shape, it is preferred for the powder to have a small coefficient of shape variation.

The hexagonal ferrite magnetic powder that can be used in the magnetic layer preferably includes magnetoplumbite type ferrites, such as barium ferrite, strontium ferrite, lead ferrite, and calcium ferrite, and their substitution derivatives. These ferrites may contain additional elements, such as Al, Si, S, Sc, Ti, V, Cr, Cu, Y, Mo, Rh, Pd, Ag, Sn, Ba, Ta, W, Re, Au, Pb, Bi, La, Ce, Pr, Nd, P, Co, Mn, Zn, Ni, Sr,B, Ge, and Nb. Usually, ferrites doped with Co—Ti, Co—Ti—Zr, Co—Nb, Co—Ti—Zn, Co—Zn—Nb, Ni—Ti—Zn, Nb—Zn, Ni—Ti, Zn—Ti, Zn—Ni, etc. can be used. From the standpoint of SFD (switching field distribution), pure magnetoplumbite type hexaferrites are preferred to composite ferrites containing a spinel phase in parts. The coercive force of the hexagonal ferrite powder can be controlled by composition, particle size (diameter and thickness), thickness of a spinel phase, amount of doping elements, site of doping in the spinel phase, and the like.

The hexagonal ferrite magnetic powder preferably has an average diameter of 15 to 35 nm and a coefficient of diameter variation of 0 to 30%. The hexagonal ferrite powder usually has an average thickness of 2 to 15 nm, preferably 4 to 10 nm. The average aspect ratio is preferably 1.5 to 4.5, still preferably 2 to 4.2. The average diameter falling within the above-recited preferred range, the specific surface area will be in a proper range, which assures dispersibility. A preferred specific surface area of the hexaferrite powder is 40 to 100 m²/g, still preferably 45 to 90 m²/g. The powder with the preferred specific surface area is easy to disperse, which is advantageous for obtaining good surface properties, and less causative of noise. A preferred water content is 0.3 to 2.0% by weight, and a pH is usually 5.0 to 12, preferably 5.5 to 10. It is advisable to optimize the water content and pH depending on the binder used in combination.

Prior to dispersing, the ferromagnetic powder may be subjected to pretreatment with a dispersant, a lubricant, a surface active agent, an antistatic agent, and so forth as described infra.

The SFD of the ferromagnetic powder itself, a measure of the spread of individual particle coercivities, is preferably as small as possible. A magnetic tape having a small SFD shows a sharp magnetization reversal with a small peak shift, which is advantageous for high-density digital magnetic recording. The coercivity distribution can be narrowed by, for example, using goethite with a narrow size distribution, using mono-dispersed α-Fe₂O₃ particles, or preventing sintering of particles.

The non-magnetic powder that can be used in the non-magnetic layer are selected from inorganic compounds, such as metal oxides, metal carbonates, metal nitrides, metal carbides, and metal sulfides. Examples of the inorganic compounds are α-alumina, β-alumina, γ-alumina, θ-alumina, silicon carbide, chromium oxide, cerium oxide, α-iron oxide, goethite, silicon nitride, titanium dioxide, silicon dioxide, tin oxide, magnesium oxide, zirconium oxide, zinc oxide, barium sulfate, and tabular AlOOH. They can be used either individually or in combination. Preferred among them are titanium dioxide, zinc oxide, alpha iron oxide, goethite, tin oxide, and barium sulfate, particularly titanium dioxide, alpha iron oxide, and goethite, because they can be produced with small particle size distribution and be endowed with a desired function through many means. Alpha iron oxide is preferably prepared by thermally dehydrating magnetic iron oxide or a raw material for metal having a narrow size distribution, annealing the powder to reduce voids, and, if necessary, surface treating the powder with an aluminum or silicon compound.

Having photocatalytic activity, titanium dioxide can generate radicals on exposure to light and react with a binder or a lubricant. Therefore, it is recommended to reduce the photocatalytic activity of titanium oxide particles by dissolving 1 to 10% of Al, Fe, etc. into the titanium oxide crystalline phase in the form of a solid solution or treating the titanium oxide particles with an aluminum or silicon compound.

The non-magnetic powder which is needle-like powder preferably has an average long axis length of 30 to 300 nm. If desired, non-magnetic powders different in particle size may be used in combination, or a single kind of a non-magnetic powder having a broadened size distribution may be used to produce the same effect. A still preferred particle size of the non-magnetic powder is 30 to 200 nm. Non-needle-like metal oxide particles as non-magnetic powder preferably have an average particle size of 30 nm or smaller.

The tap density of the non-magnetic powder is 0.4 to 1.5 g/ml, preferably 0.5 to 1.3 g/ml. The water content of the non-magnetic powder is 0.2 to 5% by weight, preferably 0.3 to 3% by weight, still preferably 0.3 to 1.5% by weight.

The non-magnetic powder preferably has a pH of 4 to 12, still preferably 5.5 to 11. The non-magnetic powder has a specific surface area (S_{BET}) of 45 to 200 m²/g, preferably 45 to 180 m²/g, still preferably 50 to 180 m²/g. The DBP (dibutyl phthalate) oil absorption is 5 to 100 ml/100 g, preferably 10 to 80 ml/100 g, still preferably 20 to 60 ml/100 g. The specific gravity is 2.0 to 7.5, preferably 3 to 7. The particle shape may be any of needle-like, spherical, polygonal and tabular shapes. The SA (stearic acid) adsorption of the non-magnetic powder is in a range of 1 to 20 μmol/m², preferably 2 to 15 μmol/m², still preferably 3 to 8 μmol/m².

Non-magnetic powder having a high SA adsorption is preferably pretreated with an organic substance that is strongly adsorbable onto the surface of the powder, which is effective to reduce the frictional coefficient of the medium. It is preferred that the non-magnetic powder be surface treated with an Al, Mg, Si, Ti, Zr, Sn, Sb, Zn or Y compound. Preferred treating compounds for improving dispersibility are Al₂O₃, SiO₂, TiO₂, ZrO₂, and MgO, and hydrates thereof, with Al₂O₃, SiO₂, and ZrO₂, and their hydrates being still preferred. These oxides may be used either individually or in combination. According to the purpose, a composite surface layer can be formed by co-precipitation or a method comprising first applying alumina to the non-magnetic particles and then treating with silica or vise versa. The surface layer may be porous for some purposes, but a homogeneous and dense surface layer is usually preferred.

Specific examples of commercially available non-magnetic powders that can be used in the non-magnetic layer include α-iron oxide series DPN-250BX, DPN-245, DPN-270BX, DPN-550BX, DBN-550RX, DBN-650RX, and DAN-850RX (from Toda Kogyo Corp.); titanium oxide series TTO-51A and TTO-S (from Ishihara Sangyo Kaisha, Ltd.); titanium oxide series MT-100S, MT-100T, MT-150W, MT-500B, MT-100F, and MT-500HD (from Tayca Corp.); FINEX-25, BF-1, BF-10, BF-20, and ST-M (from Sakai Chemical Industry Co., Ltd.); and iron oxide series DEFIC-Y and DEFIC-R (from Dowa Mining Co., Ltd.).

Carbon black can be incorporated into the non-magnetic lower layer to reduce surface resistivity and light transmission and also to obtain a desired micro Vickers hardness. Addition of carbon black is also effective in holding the lubricant. Useful carbon black species include furnace black for rubber, thermal black for rubber, carbon black for colors, conducting carbon black, and acetylene black. The characteristics of carbon black to be used, such as those described below, should be optimized according to an intended effect. Combined use of different kinds of carbon black can bring about enhancement of the effect.

The carbon black in the lower layer usually has a specific surface area (S_{BET}) of 50 to 500 m²/g, preferably 70 to 400 m²/g, a DBP oil absorption of 20 to 400 ml/100 g, preferably 30 to 400 ml/100 g, and an average particle size of 5 to 80 nm, preferably 10 to 50 nm, still preferably 10 to 40 nm. The carbon black preferably has a pH of 2 to 10, a water content of 0.1 to 10% by weight, and a tap density of 0.1 to 1 g/ml.

Specific examples of commercially available carbon black which can be used in the lower layer include Black Pearls 2000, 1300, 1000, 900, 800, 880, and 700, and Vulcan XC-72 (from Cabot Corp.); #3050B, #3150B, #3750B, #3950B, #950, #650B, #970B, #850B, MA-600, MA-230, #4000, and #4010 (from Mitsubishi Chemical Corp.); Conductex SC and RAVEN 8800, 8000, 7000, 5750, 5250, 3500, 2100, 2000, 1800, 1500, 1255, and 1250 (from Columbian Carbon); and Ketjen Black EC (from Akzo Nobel Chemicals). Carbon black having been surface treated with a dispersant, etc., resin-grafted carbon black, or carbon black with its surface partially graphitized may be used. Carbon black may previously been dispersed in a binder before being mixed up with other components to prepare a coating composition. The carbon black is used in an amount of 50% by weight or less based on the above-described inorganic powder and 40% by weight or less based on the total weight of the non-magnetic layer. The above-recited carbon black species can be used either individually or as a combination thereof. In selecting carbon black species for use in the present invention, reference can be made, e.g., in Carbon Black Kyokai (ed.), Carbon Black Binran.

The lower layer can contain organic powder according to the purpose. Useful organic powders include acrylic-styrene resin powders, benzoquanamine resin powders, melamine resin powders, and phthalocyanine pigments. Polyolefin resin powders, polyester resin powders, polyamide resin powders, polyimide resin powders, and polyethylene fluoride resin powders are also usable. Methods of preparing these resin powders include those disclosed in JP-A-62-18564 and JP-A-60-255827.

With respect to the other techniques involved in forming the lower layer, i.e., the kinds and amounts of binder resins, lubricants, dispersants, additives, and solvents, methods of dispersion, and the like, the foregoing description as for the magnetic layer applies.

An abrasive, which can also serve as a reinforcing agent, can be added to the lower layer. Known abrasives mostly having a Mohs hardness of 6 or higher can be used in the present invention. Such abrasives include α-alumina having an α-phase content of 90% or more, β-alumina, silicon carbide, chromium oxide, cerium oxide, α-iron oxide, corundum, silicon nitride, titanium carbide, titanium oxide, silicon dioxide, and boron nitride. These abrasives can be used either individually or as a mixture thereof or as a composite thereof (an abrasive surface treated with another). Existence of impurity compounds or elements, which are sometimes observed in the abrasives, will not affect the effect as long as the content of the main component is 90% by weight or higher. The abrasives preferably have an average particle size of 0.01 to 1 μm. In order to improve electromagnetic characteristics, in particular, it is desirable for the abrasives to have a narrow size distribution. In order to improve durability, abrasives different in particle size may be used in combination, or a single kind of an abrasive having a broadened size distribution may be used to produce the same effect. The abrasives preferably have a tap density of 0.3 to 1.5 g/ml, a water content of 0.1 to 5% by weight, a pH of 3 to 11, and a specific surface area (S_{BET}) of 5 to 50 m²/g. The abrasive grains may be needle-like, spherical or cubic. Angular grains are preferred for high abrasive performance.

Specific examples of commercially available abrasives that can be used in the invention are AKP-10, AKP-15, AKP-20, AKP-30, AKP-50, HIT-50, HIT-60A, HIT-60G, HIT-70, HIT-80, HIT-82, HIT-100, and Sumicorundum series AA-01, AA-03, AA-04 and AA-06 (from Sumitomo Chemical Co., Ltd.); ERC-DBM, HP-DBM, and HPS-DBM (from Reynolds Metals Co.); WA10000 (from Fujimi Kenmazai K.K.); UB 20 (from Uyemura & CO., LTD); G-5, Chromex U2, and Chromex U1 (from Nippon Chemical Industrial Co., Ltd.); TF100 and TF140 (from Toda Kogyo Corp.); Beta-Random Ultrafine (from Ibiden Co., Ltd.); and B-3 (from Showa Mining Co., Ltd.).

Incorporation of the abrasive into the lower layer makes it feasible to control the surface profile or the projecting conditions of the abrasive grains on the coating layer. Needless to say, the particle size and the amount of the abrasive added to the lower layer should be optimized.

Binders used in the magnetic layer and the non-magnetic layer include conventionally known thermoplastic resins, thermosetting resins and reactive resins, and mixtures thereof. Thermoplastic resins used as a binder generally have a glass transition temperature of −100 to 150° C., an number average molecular weight of 1,000 to 200,000, preferably 10,000 to 100,000, and a degree of polymerization of about 50 to 1000.

Such thermoplastic resins include homo- or copolymers containing a unit derived from vinyl chloride, vinyl acetate, vinyl alcohol, maleic acid, acrylic acid, an acrylic ester, vinylidene chloride, acrylonitrile, methacrylic acid, a methacrylic ester, styrene, butadiene, ethylene, vinyl butyral, vinyl acetal, a vinyl ether, etc.; polyurethane resins, and various rubber resins. Useful thermosetting or reactive resins include phenolic resins, epoxy resins, thermosetting polyurethane resins, urea resins, melamine resins, alkyd resins, reactive acrylic resins, formaldehyde resins, silicone resins, epoxy-polyamide resins, polyester resin/isocyanate prepolymer mixtures, polyester polyol/polyisocyanate mixtures, and polyurethane/polyisocyanate mixtures. For the details of these resin binders, Plastic Handbook, Asakura Shoten (publisher) can be referred to. Known electron beam (EB)-curing resins can also be used in each layer. The details of the EB-curing resins and methods of producing them are described in JP-A-62-256219. The above-recited resins can be used either individually or as a combination thereof. Preferred resins are a combination of a polyurethane resin and at least one resin selected from polyvinyl chloride, a vinyl chloride-vinyl acetate copolymer, a vinyl chloride-vinyl acetate-vinyl alcohol copolymer, a vinyl chloride-vinyl acetate-maleic anhydride copolymer, and an acrylic resin, and a combination of the above-described combination and polyisocyanate.

The polyurethane resin includes those of known structures, such as polyester polyurethane, polyether polyurethane, polyether polyester polyurethane, polycarbonate polyurethane, polyester polycarbonate polyurethane, and polycaprolactone polyurethane.

In order to ensure dispersing capabilities and durability, it is preferred to introduce into the above-recited binder resins at least one polar group by copolymerization or through addition reaction, the polar group being selected from —COOM, —SO₃M, —OSO₃M, —P═O(OM)₂, —O—P═O (OM)₂ (wherein M is a hydrogen atom or an alkali metal), OH, NR₂, N⁺R₃ (wherein R is a hydrocarbon group), an epoxy group, SH, CN, and the like. The amount of the polar group to be introduced is 10⁻¹ to 10⁻⁸ mol/g, preferably 10⁻² to 10⁻⁶ mol/g.

Examples of commercially available binder resins which can be used in the invention are VAGH, VYHH, VMCH, VAGF, VAGD, VROH, VYES, VYNC, VMCC, XYHL, XYSG, PKHH, PKHJ, PKHC, and PKFE (from Union Carbide Corp.) ; MPR-TA, MPR-TA5, MPR-TAL, MPR-TSN, MPR-TMF, MPR-TS, MPR-TM, and MPR-TAO (from Nisshin Chemical Industry Co., Ltd.); 1000w, DX80, DX81, DX82, DX83, and 100FD (from Denki Kagaku Kogyo K.K.); MR-104, MR-105, MR110, MR100, MR555, and 400X-110A (from Zeon Corp.); Nipporan series N2301, N2302, and N2304 (from Nippon Polyurethane Industry Co., Ltd.); Pandex series T-5105, T-R3080, and T-5201, Barnock series D-400 and D-210-80, and Crisvon series 6109 and 7209 (from Dainippon Ink & Chemicals, Inc.); Vylon UR series 8200, 8300, and 8700, RV530, and RV280 (from Toyobo Co., Ltd.); Daiferamin series 4020, 5020, 5100, 5300, 9020, 9022, and 7020 (from Dainichiseika Color & Chemicals Mfg. Co., Ltd.); MX5004 (from Mitsubishi Chemical Corp.); Sanprene SP-150 (from Sanyo Chemical Industries, Ltd.); and Saran F series 310 and 210(from Asahi Chemical Industry Co., Ltd.).

The polyisocyanate that can be used in the invention includes tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate, and triphenylmethane triisocyanate. Further included are reaction products between these isocyanate compounds and polyols and polyisocyanates produced by condensation of the isocyanates. Examples of commercially available polyisocyanates useful in the invention are Coronate L, Coronate HL, Coronate 2030, Coronate 2031, Millionate MR, and Millionate MTL (from Nippon Polyurethane Industry Co., Ltd.); Takenate D-102, Takenate D-110N, Takenate D-200, and Takenate D-202 (from Takeda Chemical Industries, Ltd.) ; and Desmodur L, Desmodur IL, Desmodur N, and Desmodur HL (from Sumitomo Bayer Urethane Co., Ltd.). They can be used in each layer, either alone or as a combination of two or more thereof taking advantage of difference in curing reactivity.

The binder is used in the non-magnetic layer and the magnetic layer in an amount of 5 to 50% by weight, preferably 10 to 30% by weight, based on the non-magnetic powder or the total weight of the ferromagnetic powder and, if any, non-magnetic powder, respectively. Where a vinyl chloride resin, a polyurethane resin, and polyisocyanate are used in combination, their amounts are selected from a range of 5 to 30% by weight, a range of 2 to 20% by weight, and a range of 2 to 20% by weight, respectively. In case where head corrosion by a trace amount of released chlorine is expected to occur, polyurethane alone or a combination of polyurethane and polyisocyanate can be used. The polyurethane to be used preferably has a glass transition temperature of −50° to 150° C., preferably 0° to 100° C., an elongation at break of 100 to 2000%, a stress at rupture of 0.05 to 10 kg/mm² (0.49 to 98 Mpa), and a yield point of 0.05 to 10 kg/mm² (0.49 to 98 Mpa).

The magnetic recording medium of the invention has at least two layers on the support, the non-magnetic layer and the magnetic layer. These layers can have different binder formulations in terms of the binder content, the proportions of a vinyl chloride resin, a polyurethane resin, polyisocyanate, and other resins, the molecular weight of each resin, the amount of the polar group introduced, and other physical properties of the resins. It is rather desirable to optimize the binder design for each layer. For the optimization, known techniques relating to a non-magnetic/magnetic multilayer structure can be utilized. For example, to increase the binder content of the magnetic layer is effective to reduce scratches on the magnetic layer, or to increase the binder content of the non-magnetic layer is effective to increase flexibility thereby to smooth head touch.

An abrasive can be added to the magnetic layer to provide the magnetic layer with a head cleaning effect and improved durability. It is desired for the abrasive added to the magnetic layer to have an average particle size of 0.01 to 0.25 μm and a Mohs hardness of 5 or higher. Known abrasives mostly having a Mohs hardness of 5 or higher can be used in the magnetic layer. Such abrasives include α-alumina having an α-phase content of 90% or more, β-alumina, silicon carbide, chromium oxide, cerium oxide, α-iron oxide, corundum, silicon nitride, titanium carbide, titanium oxide, silicon dioxide, and boron nitride. These abrasives can be used either individually or as a mixture thereof or as a composite thereof (an abrasive surface treated with another). Existence of impurity compounds or elements, which are sometimes observed in the abrasives, will not affect the effect as long as the content of the main component is 90% by weight or higher. In order to improve electromagnetic characteristics, it is desirable for the abrasives to have a narrow size distribution.

In order to improve durability, abrasives different in particle size may be used in combination, or a single kind of an abrasive having a broadened size distribution may be used to produce the same effect. The abrasives preferably have a tap density of 0.3 to 1.5 g/ml, a water content of 0.1 to 5% by weight, a pH of 3 to 11, and a specific surface area (S_{BET}) of 10 to 80 m²/g. The abrasive grains may be needle-like, spherical or cubic. Angular grains are preferred for high abrasive performance.

Specific examples of commercially available abrasives that can be used in the magnetic layer are AKP-30, AKP-50, AKP-80, AKP-100, HIT-50, HIT-60A, HIT-60G, HIT-70, HIT-80, HIT-82, HIT-100, and Sumicorundum AA-03 (from Sumitomo Chemical Co., Ltd.); UB 40B (from Uyemura & CO., LTD); micron sized diamond powders (graded 0-¼, 0-⅙ or 0-⅛) available from Tomei Diamond Co., Ltd., Lands Superabrasives Co., E.I. du Pont, General Electric Co., etc.; and TF100, TF140, and TF180 (from Toda Kogyo Corp.).

While abrasives having an average grain size of 0.01 to 0.5 μm are effective, an average grain size of 0.01 to 0.25 μm is advisable for use in the magnetic layer from the standpoint of surface roughness and surface defects of the medium. An average grain size of 0.02 to 0.15 μm is still preferred. The abrasives are used in a total amount of 1 to 20 parts by weight, preferably 1 to 15 parts by weight, per 100 parts of the ferromagnetic powder. Use of abrasives in that amount results in sufficient durability, improved surface properties, and increased packing density. The abrasives may previously be dispersed in a binder or a dispersant before being mixed up with other components to prepare a magnetic coating composition.

The magnetic layer and the non-magnetic layer can contain other additives capable of producing lubricating effects, antistatic effects, dispersing effects, plasticizing effects, and the like. Such additives include molybdenum disulfide, tungsten disulfide, graphite, boron nitride, graphite fluoride, silicone oils, polar group-containing silicones, fatty acid-modified silicones, fluorine-containing silicones, fluorine-containing alcohols, fluorine-containing esters, polar group-containing perfluoropolyethers, polyolefins, polyglycols, alkylphosphoric esters and alkali metal salts thereof, alkylsulfuric esters and alkali metal salts thereof, polyphenyl ethers, phenylphosphonic acid, α-naphtylphosphoric acid, phenylphosphoric acid, diphenylphosphoric acid, p-ethylbenzenephosphonic acid, phenylphosphinic acid, aminoquinones, various silane coupling agents, titan coupling agents, fluorine-containing alkylsulfuric ester and their alkali metal salts, saturated or unsaturated, straight-chain or branched monobasic fatty acids having 10 to 24 carbon atoms and their metal (e.g., Li, Na, K, Cu) salts, saturated or unsaturated, straight-chain or branched mono-to hexahydric alcohols having 12 to 22 carbon atoms, alkoxyalcohols having 12 to 22 carbon atoms, mono-, di- or tri-fatty acid esters between saturated or unsaturated, straight-chain or branched monobasic fatty acids having 10 to 24 carbon atoms and at least one of mono- to hexahydric, saturated or unsaturated, and straight-chain or branched alcohols having 2 to 12 carbon atoms, fatty acid esters of polyalkylene oxide monoalkyl ethers, fatty acid amides having 8 to 22 carbon atoms, and aliphatic amines having 8 to 22 carbon atoms.

Examples of the fatty acids are capric acid, caprylic acid, lauric acid, myristic acid, palmitic acid, stearic acid, behenic acid, oleic acid, elaidic acid, linoleic acid, linolenic acid, and isostearic acid. Examples of the esters are butyl stearate, octyl stearate, amyl stearate, isooctyl stearate, butyl myristate, octyl myristate, butoxyethyl stearate, butoxydiethyl stearate, 2-ethylhexyl stearate, 2-octyldodecyl palmitate, 2-hexyldodecyl palmitate, isohexadecyl stearate, oleyl oleate, dodecyl stearate, tridecyl stearate, oleyl erucate, neopentyl glycol didecanoate, and ethylene glycol dioleate. Examples of the alcohols are oleyl alcohol, stearyl alcohol, and lauryl alcohol.

The magnetic layer and the non-magnetic layer can contain surface active agents. Useful surface active agents include nonionic ones, such as alkylene oxide types, glycerol types, glycidol types, and alkylphenol ethylene oxide adducts; cationic ones, such as cyclic amines, ester amides, quaternary ammonium salts, hydantoin derivatives, heterocyclic compounds, phosphonium salts, and sulfonium salts; anionic ones containing an acidic group, such as a carboxyl group, a sulfonic acid group, a phosphoric acid group, a sulfuric ester group or a phoshoric ester group; and amphoteric ones, such as amino acids, aminosulfonic acids, amino alcohol sulfuric or phosphoric esters, and alkyl betaines. For the details of the surface active agents, refer to Kaimen Kasseizai Binran published by Sangyo Tosho K.K.

The above-recited lubricants, antistaticagents, and like additives do not always need to be 100% pure and may contain impurities, such as isomers, unreacted materials, by-products, decomposition products, and oxides. Nevertheless, the proportion of the impurities is preferably 30% by weight at the most, still preferably 10% by weight or less.

Since the physical actions of these additives vary among individuals, the kind and amount of an additive or the mixing ratio of additives used in combination for producing a synergistic effect should be determined so as to produce optimum results according to the purpose. The following is a few examples of conceivable manipulations using additives. (1) Bleeding of fatty acid additives is suppressed by using fatty acids having different melting points between the magnetic layer and the non-magnetic layer. (2) Bleeding of ester additives is suppressed by using esters different in boiling point, melting point or polarity between the magnetic layer and the non-magnetic layer. (3) Coating stability is improved by adjusting the amount of a surface active agent. (4) The amount of the lubricant in the non-magnetic layer is increased to improve the lubricating effect. The total amount of the lubricants to be used in the magnetic or non-magnetic layer is generally selected from a range of 0.1 to 50% by weight, preferably 2 to 25% by weight, based on the magnetic or non-magnetic powder.

All or part of the additives can be added at any stage of preparing the magnetic or non-magnetic coating composition. For example, the additives can be blended with the magnetic powder before kneading, be mixed with the magnetic powder, the binder, and a solvent in the step of kneading, or be added during or after the step of dispersing or immediately before coating. The purpose of using an additive could be achieved by applying a part of, or the whole of, the additive on the magnetic layer surface either by simultaneous coating or successive coating, which depends on the purpose. A lubricant could be applied to the magnetic layer surface even after calendering or slitting, which depends on the purpose.

Known organic solvents, e.g., those described in JP-A-6-68453, can be used in the preparation of magnetic and non-magnetic coating compositions.

The thickness of the support generally ranges from 2.5 to 100 μm. More specifically, the thickness of the support for tapes is preferably 2.5 to 10 μm, still preferably 3.0 to 8 μm, in order to secure a large volume density, and that for disks is preferably 20 to 100 μm, still preferably 25 to 80 μm.

An undercoating layer for adhesion improvement may be provided between the support and the non-magnetic layer. The undercoating layer usually has a thickness of 10 to 500 nm, preferably 20 to 300 nm. Furthermore, a backcoating layer may be provided on the side opposite to the magnetic layer side for static prevention and curling correction. The backcoating layer usually has a thickness of 0.1 to 2.0 μm, preferably 0.3 to 1.0 μm. The undercoating layer and the backcoating layer can be of known materials.

The thickness of the magnetic layer is 25 to 150 nm, preferably 25 to 100 nm, still preferably 25 to 90 nm, while it is to be optimized according to the saturation magnetization and the gap length of a head used and the wavelength range of recording signals. With the magnetic layer's thickness being in that range, the magnetic layer has uniformity, the self demagnetization reduces, the transition noise reduces, and the resolution increases.

The magnetic layer may be divided into two or more layers different in magnetic characteristics. Known techniques relating to a multilayered magnetic layer apply to that structure.

The thickness of the non-magnetic layer ranges 0.5 to 2.5 μm, preferably 0.6 to 2.5 μm, still preferably 0.7 to 2.5 μm. The non-magnetic lower layer manifests the essentially expected effects as long as it is substantially non-magnetic. In other words, the effects of the lower layer are produced even where it contains a small amount of a magnetic substance, either intentionally or unintentionally. Such a layer formulation is construed as being included under the scope of the present invention. The term “substantially non-magnetic” as referred to above means that the lower layer has a residual magnetic flux density of 50 mT or less or a coercive force of not more than 40% of that of the upper magnetic layer. Preferably, both the residual magnetic flux density and coercive force of the lower layer are zero.

The support that can be used in the invention includes films of known materials, such as polyesters (e.g., polyethylene terephthalate and polyethylene naphthalate), polyolefins, cellulose triacetate, polycarbonate, polyamides (including aliphatic polyamides and aromatic polyamides, e.g., aramid), polyimide, polyamideimide, polysulfone, and polybenzoxazole. High strength supports of polyethylene naphthalate or aramid are preferred. If desired, a laminated support, such as the one disclosed in JP-A-3-224127, can be used to provide different surface profiles between the magnetic layer side and the back side. The support may be subjected to surface treatment, such as corona discharge treatment, plasma treatment, treatment for easy adhesion, heat treatment, and dustproof treatment. An alumina or glass support could also be employed.

In order to accomplish the object of the invention, it is desirable to use a support having a three dimensional mean surface roughness (Sa) of 6.0 nm or smaller, preferably 4.0 nm or smaller, still preferably 2.0 nm or smaller, as measured with a three-dimensional profilometer TOPO-3D supplied by Wyko. It is desirable for the support to have not only a small mean surface roughness but no projections of 0.5 μm or higher. The surface profile is controlled arbitrarily by the size and amount of fillers added to the support where necessary. Useful fillers include oxides and carbonates of Ca, Si, Ti, etc. and organic fine powders of acrylic resins, etc. The surface profile of the support preferably has a maximum height Sₘₐₓ of 1 μm or smaller, a 10 point average roughness S_{z} of 0.5 μm or smaller, a maximum peak-to-mean plane height Sₚ of 0.5 μm or smaller, a maximum mean plane-to-valley depth Sᵥ of 0.5 μm or smaller, a mean plane area ratio Sr of 10 to 90%, and an average wavelength Sλₐ of 5 to 300 μm. The projection distribution on the support surface can be controlled arbitrarily by the filler to obtain desired electromagnetic characteristics and durability. The number of projections of 0.01 to 1 μm per 0.1 mm²is controllable between 0 and 2000.

The support preferably has an F5 value of 5 to 50 kg/mm² (49 to 490 Mpa), a thermal shrinkage of 3% or less, particularly 1.5% or less, at 100° C.×30 minutes and of 1% or less, particularly 0.5% or less, at 80° C.×30 minutes, a breaking strength of 5 to 100 kg/mm² (49 to 980 MPa), an elastic modulus of 100 to 2000 kg/mm² (0.98 to 19.6 GPa), a coefficient of temperature expansion of 10⁻⁴ to 10⁻⁸/° C., particularly 10⁻⁵ to 10⁻⁶/° C., and a coefficient of humidity expansion of 10⁻⁴/RH % or less, particularly 10⁻⁵/RH % or less. It is desirable for the support to be isotropic such that the differences in these thermal, dimensional, and mechanical characteristics in all in-plane directions are within 10%.

Methods of preparing the magnetic and non-magnetic coating compositions include at least the steps of kneading and dispersing and, if desired, the step of mixing which is provided before or after the step of kneading and/or the step of dispersing. Each step may be carried out in two or more divided stages. Any of the materials, including the magnetic powder, non-magnetic powder, binder, abrasive, conductive powder, antistatic, lubricant, and solvent, can be added at the beginning of or during any step. Individual materials may be added in divided portions in two or more steps. For example, polyurethane may be added dividedly in the kneading step, the dispersing step, and a mixing step provided for adjusting the viscosity of the dispersion. To accomplish the object of the invention, known techniques for coating composition preparation can be applied as apart of the method. The kneading step is preferably performed using a kneading machine with high kneading power, such as an open kneader, a continuous kneader, a pressure kneader, and an extruder. In using a kneader, the magnetic or non-magnetic powder, part (preferably at least 30% by weight of the total binder) or the whole of the binder, and 15 to 500 parts by weight of a solvent per 100 parts by weight of the magnetic or non-magnetic powder are kneaded. For the details of the kneading operation, reference can be made in JP-A-1-106338 and JP-A-1-79274. In the step of dispersing, glass beads can be used to disperse the magnetic or non-magnetic mixture. Zirconia beads, titania beads or steel beads, which are high-specific-gravity dispersing media, are suitable. The size and mixing ratio of the dispersing medium should be optimized. Known dispersing machines can be used. The magnetic powder, abrasive, conductive powder, etc. that show different rates of dispersing may be separately dispersed, and the resulting dispersions are mixed up and, if needed, more finely dispersed to prepare a coating composition.

The magnetic recording medium of the present invention has a multilayer structure containing at least two layers on a support, which effectively contributes to achievement of high recording density. According to the process of the invention, the upper magnetic layer is preferably provided after the lower coating applied to the support is dried. If desired, the magnetic layer may be provided after the support having the lower layer formed thereon is taken up in a roll form and calendered. The process of the invention can be embodied by, for example, the following coating methods.

(a) A method comprising applying a non-magnetic coating composition by means of a coating apparatus generally employed for a magnetic coating composition, such as a gravure coater, a roll coater, a blade coater or an extrusion coater, drying the coating film to form a lower non-magnetic layer, and applying a magnetic coating composition by means of the extrusion coating apparatus disclosed in JP-B-1-46186, JP-A-60-238179, and JP-A-2-265672 while scraping the applied coating to a predetermined thickness.

(b) A method comprising applying a non-magnetic coating composition by means of a coating apparatus generally employed for a magnetic coating composition, such as a gravure coater, a roll coater, a blade coater or an extrusion coater, drying the coating film to form a lower non-magnetic layer, and applying a magnetic coating composition by means of the coating head disclosed in JP-A-63-88080, JP-A-2-17971, and JP-A-2-265672. The coating head has two slits through which liquid may pass. The magnetic coating composition is applied through the front slit, and the applied coating composition is sucked up through the rear slit to leave a prescribed coating thickness.

In carrying out the process of the invention, it is desirable to take care in selecting the binder resins and solvents to be used in the lower and upper layers so that the lower layer may not be denatured on applying the magnetic coating composition.

Calendering of the lower layer or the magnetic layer is carried out with metallic rolls or rolls of heat-resistant plastics, such as epoxy resins, polyimide, polyamide and polyimide-amide. Calendering between metallic rolls is preferred in making a double-sided magnetic recording medium. The calendering temperature is preferably 50° C. or higher, still preferably 100° C. or higher. The linear pressure of calender rolls is preferably 200 kg/cm (196 kN/m) or higher, still preferably 225 to 300 kg/cm (220 to 294 kN/m), so as to fluidize an excess of the binder thereby to reduce the frictional coefficient and prevent head clogging.

The magnetic recording medium of the invention has a frictional coefficient of 0.5 or less, preferably 0.3 or less, against a head at temperatures of −10° to 40° C. and humidities of 0 to 95%. The surface resistivity on the magnetic surface is preferably 10⁴ to 10¹² Ω/sq. The static potential is preferably −500 to +500 V. The magnetic layer preferably has an elastic modulus at 0.5% elongation of 100 to 2000 kg/mm² (980 to 19600 N/mm²) in every in-plane direction and a breaking strength of 10 to 70 kg/mm² (98 to 686 N/mm²). The magnetic recording medium preferably has an elastic modulus of 100 to 1500 kg/mm² (980 to 14700 N/mm²) in every in-plane direction, a residual elongation of 0.5% or less, and a thermal shrinkage of 1% or less, particularly 0.5% or less, especially 0.1% or less, at temperatures of 100° C. or lower. The glass transition temperature (maximum loss elastic modulus in dynamic viscoelasticity measurement at 110 Hz) of the magnetic layer is preferably 50° to 120° C., and that of the non-magnetic lower layer is preferably 0° to 100° C. The loss elastic modulus preferably ranges 1×10³ to 8×10⁴ N/cm². The loss tangent is preferably 0.2 or lower. Too high a loss tangent easily leads to a tack problem. It is desirable that these thermal and mechanical characteristics be substantially equal in all in-plane directions with differences falling within 10%. The residual solvent content in the magnetic layer is preferably 100 mg/m² or less, still preferably 10 mg/m² or less. The magnetic layer and the non-magnetic layer each preferably have a void of 30% by volume or less, still preferably 20% by volume or less. While a lower void is better for high output, there are cases in which a certain level of void is recommended in some applications.

With respect to the 3D surface profile of the magnetic layer as measured with TOPO-3D (Wyko), the mean surface roughness Sa is usually 3.0 nm or less, preferably 2.8 nm or less, still preferably 2.5 nm or less. The 3D surface profile preferably has a maximum height Sₘₐₓ of 0.5 μm or smaller, a 10 point average roughness S_{z} of 0.3 μm or smaller, a maximum mean plane-to-peak height Sₚ of 0.3 μm or smaller, a maximum mean plane-to-valley depth Sᵥ of 0.3 μm or smaller, a mean plane area ratio Sr of 20 to 80%, and an average wavelength Sλₐ of 5 to 300 μm. The number of projections of 0.01 to 1 μm per 0.1 mm²of the magnetic layer is arbitrarily controllable between 0 and 2000. It is preferred to control the projection distribution on the magnetic layer to optimize the electromagnetic characteristics and the frictional coefficient of the magnetic recording medium. These surface profile parameters of the magnetic layer are easily controlled by controlling the surface profile of the support (which can be done by means of a filler as previously mentioned), by adjusting the particle size and amount of powders used in the magnetic layer, and by selecting the surface profile of calendering rolls. Curling of the magnetic recording medium is preferably within ±3 mm.

Where the magnetic recording medium has a magnetic layer and a non-magnetic layer as in the present invention, it is easily anticipated that the physical properties are varied between these layers according to the purpose. For example, the elastic modulus of the magnetic layer can be set relatively high to improve running durability, while that of the non-magnetic layer can be set relatively low to improve head contact.

The particle size of various powders used in the invention including ferromagnetic metal powder, hexagonal ferrite powder, and carbon black is measured from high-resolution transmission electron micrographs with the aid of an image analyzer. The outline of particles on micrographs is traced with the image analyzer to obtain the particle size. The particle size is represented by (1) the length of a major axis where a particle is needle-shaped, spindle-shaped or columnar (with the height greater than the maximum diameter of the base) like ferromagnetic metal powder, (2) a maximum diameter of a main plane or a base where a particle is tabular or columnar (with the height smaller than the maximum diameter of the base) like hexagonal ferromagnetic powder, or (3) a circle equivalent diameter where a particle is spherical, polygonal or amorphous and has no specific major axis. The “circle equivalent diameter” is calculated from a projected area.

The average particle size of powder is an arithmetic mean calculated from the particle sizes of about 400 to 500 primary particles measured as described above. The term “primary particles” denotes particles dependent of each other without agglomeration.

The term “average particle size” as used herein refers to the “average major axis length” of particles having the shape identified in (1) above; the “average diameter” of particles having the shape identified in (2); or the “average circle equivalent diameter” of particles having the shape identified in (3). The average aspect ratio of powder is an arithmetic mean of major axis length/minor axis length ratios of particles defined in (1) above or an arithmetic mean of diameter/thickness ratios of particles defined in (2) above. The term “minor axis length” as used herein means the maximum length of axes perpendicular to the major axis of a particle defined in (1) above. In connection to particle size distribution, the “coefficient of variation” is defined to be a percentage of standard deviation to mean.

### EXAMPLES

The present invention will now be illustrated in greater detail with reference to Preparation Examples and Examples, but it should be understood that the invention is not construed as being limited thereto. Unless otherwise noted, all the percents and parts are by weight.

### Preparation Examples 1 to 7

Preparation of Hematite Powder:

To a 50 liter volume cylindrical reactor equipped with a stirrer and a gas inlet were put 15 l of a deaerated 1 mol/l aqueous solution of ferrous sulfate and 3.6 l of 9.4N sodium hydroxide, followed by pure water to make 20 l while bubbling with nitrogen. The mixture was stirred and warmed to 40° C. while bubbling with nitrogen, and 10 l of a solution containing 1.65 mol of ammonium hydrogen carbonate was added thereto. The reaction mixture was maintained at the aging temperature shown in Table 1 below for 60 minutes while bubbling with nitrogen. The liquid temperature was then adjusted to the air oxidation temperature shown in Table 1, and air was bubbled at a rate of 20 l/min (wet reaction). The resulting spindle-shaped goethite was collected by filtration, washed with water to remove by-products, re-dispersed in water in 3% concentration, and ground to powder in a horizontal sand grinder.

An aqueous solution of sodium silicate was added to the slurry in an amount corresponding to 1% in terms of SiO₂ based on the goethite powder, followed by stirring. The slurry was adjusted to pH 6.5 with carbon dioxide gas. After aging for 30 minutes, the slurry was filtered, and the filter cake was washed with water and dried to complete anti-sintering treatment.

The SiO₂-treated goethite powder was put in a rotary kiln and dehydrated by firing followed by annealing at the respective temperatures shown in Table 1 to obtain hematite powder. The resulting hematite powder was observed with a transmission electron microscope (TEM) to obtain an average particle size (long axis length) and an average aspect ratio. The results of the TEM observation and S_{BET} measurement on the resulting hematite powder are shown in Table 1.

The hematite powder was dispersed in pure water in a horizontal sand grinder to prepare a 4% slurry. The slurry was adjusted to pH 10.5 with a sodium hydroxide aqueous solution and heated to 45°, and a 1.0 mol/l solution of sodium aluminate was added to the slurry in an amount corresponding to 1.0% in terms of Al based on the hematite powder, followed by gently stirring for 30 minutes. The slurry was adjusted to pH 7.0 with carbon dioxide gas. After aging for 30 minutes, the slurry was filtered, and the filter cake was washed with water, dried, and ground to obtain hematite powder having been surface-treated with aluminum hydroxide. The resulting surface-treated hematite powder was observed with a TEM to give results that were in agreement with those of the non-treated one within the errors of measurement. The results of S_{BET} measurement on the surface-treated hematite powder are shown in Table 1. The thus prepared surface-treated hematite powder was used as non-magnetic powder of a non-magnetic coating composition for a lower layer.

TABLE 1

| | Wet Reaction | | Goethite | | | | | Hematite | | | |
|---|---|---|---|---|---|---|---|---|---|---|---|
| | | Air | Average | | | Heat Treatment | | Average | | | S_{BET} after |
| | Aging | Oxidation | Long Axis | Average | | Dehdration | Annealing | Long Axis | Average | | Surface |
| Prepn. | Temp. | Temp. | Length | Aspect | S_{BET} | Temp. | Temp. | Length | Aspect | S_{BET} | Treatment |
| Example | (° C.) | (° C.) | (nm) | Ratio | (m²/g) | (° C.) | (° C.) | (nm) | Ratio | (m²/g) | (m²/g) |
| 1 | 50 | 57 | 250 | 10 | 70 | 450 | 650 | 220 | 11.2 | 44.3 | 41.6 |
| 2 | 50 | 50 | 175 | 7.5 | 88 | 450 | — | 160 | 7.7 | 143 | 135 |
| 3 | 50 | 50 | 175 | 7.5 | 88 | 450 | 650 | 155 | 6.5 | 56.1 | 53.1 |
| 4 | 45 | 50 | 125 | 6.5 | 132 | 450 | — | 115 | 6.3 | 120 | 108 |
| 5 | 45 | 50 | 125 | 6.5 | 132 | 450 | 650 | 110 | 6.1 | 58.6 | 54.5 |
| 6 | 45 | 45 | 75 | 6.3 | 175 | 450 | — | 69 | 5.8 | 105 | 95.7 |
| 7 | 45 | 45 | 75 | 6.3 | 175 | 450 | 650 | 66 | 5.6 | 62.5 | 57.5 |

### Preparation Example 8

1) Preparation of Magnetic Layer Coating Composition 1

| | |
|---|---|
| Ferromagnetic alloy powder | |
| Hc: 187.5 kA/m; σs: 115 A · m²/kg; S_{BET}: 67 m²/g; | 100 parts |
| average long | |
| axis length: 60 nm; coefficient of long axis length | |
| variation: 24%; composition: Fe/Co/Al/Y = 100/42/8.5/15 | |
| (atom %); anti-sintering agent: Al₂O₃ and Y₂O₃) | |
| Binder resin | |
| Vinyl chloride copolymer (—SO₃K content: 1 × 10⁻⁴ eq/g; | 13 parts |
| degree of polymerization: 300) | |
| Polyester polyurethane resin (neopentyl | 5 parts |
| glycol/caprolactone | |
| polyol/diphenylmethane-4,4′-diisocyanate | |
| (MDI) = 0.9/2.6/1 (by mole); —SO₃Na | |
| content: 1 × 10⁻⁴ eq/g) | |
| α-Alumina (average particle size: 0.11 μm) | 4 parts |
| Carbon black (average particle size: 40 nm; coefficient of | 2.5 parts |
| particle size variation: 200%) | |
| Phenylphosphonic acid | 3 parts |
| Butyl stearate | 3 parts |
| Stearic acid | 3 parts |
| Methyl ethyl ketone/cyclohexanone (1/1 by weight) | 280 parts |

The ferromagnetic alloy powder, carbon black, and vinyl chloride copolymer were kneaded together with 130 parts (out of 280 parts) of the 1:1 mixed solvent of methyl ethyl ketone and cyclohexanone in a kneader. The rest of the above components were mixed therein, and the mixture was dispersed in a sand grinder together with zirconia beads of 1 mm in diameter. Six parts of polyisocyanate was added to the dispersion, and 20 parts of a 1:1 (by weight) mixed solvent of methyl ethyl ketone and cyclohexanone was further added thereto, followed by filtration through a filter having an average opening size of 1 μm to prepare magnetic coating composition 1.

2) Preparation of Magnetic Coating Composition 2

| | |
|---|---|
| Hexagonal ferrite powder | |
| Hc: 170 kA/m; σs: 53.5 A · m²/kg; | 100 parts |
| average diameter: 30.5 nm; | |
| coefficient of diameter variation: 23%; average aspect | |
| ratio: 3.8; S_{BET}: 52.4 m²/g; composition: | |
| Ba/Fe/Co/Zn/Nb = 8.5/100/0.9/4.4/1.9 (atom %)) | |
| Binder resin | |
| Vinyl chloride copolymer (—SO₃K content: 1 × 10⁻⁴ eq/g; | 11 parts |
| degree of polymerization: 300) | |
| Polyester polyurethane resin (neopentyl | 10 parts |
| glycol/caprolactone polyol/MDI = 0.9/2.6/1 (by mole); | |
| —SO₃Na content: 1 × 10⁻⁴ eq/g) | |
| α-Alumina (average particle size: 0.11 μm) | 10 parts |
| Carbon black (average particle size: 40 nm; coefficient of | 2.0 parts |
| particle size variation: 200%) | |
| Butyl stearate | 1.5 parts |
| Stearic acid | 2.5 parts |
| Methyl ethyl ketone/cyclohexanone (1/1 by weight) | 250 parts |

The hexagonal ferrite powder, carbon black, and vinyl chloride copolymer were kneaded together with 130 parts (out of 250 parts) of the 1:1 mixed solvent of methyl ethyl ketone and cyclohexanone in a kneader. The rest of the above components were mixed therein, and the mixture was dispersed in a sand grinder together with zirconia beads of 1 mm in diameter. Six parts of polyisocyanate was added to the dispersion, and 20 parts of a 1:1 (by weight) mixed solvent of methyl ethyl ketone and cyclohexanone was further added thereto, followed by filtration through a filter having an average opening size of 1 μm to prepare magnetic coating composition 2.

### Preparation 9

Preparation of Non-Magnetic Coating Compositions:

Formulation 1:

| | |
|---|---|
| Acicular hematite (non-magnetic powder shown in Table 2) | 80 parts |
| Carbon black (Conductex SC-U) | 20 parts |
| Vinyl chloride copolymer (MR110 from Zeon Corp.) | 12 parts |
| Polyurethane resin (UR8200 from Toyobo) | 5 parts |
| Stearic acid | 3 parts |
| Butyl stearate | 1 part |
| Butoxyethyl stearate | 1 part |
| Isohexadecyl stearate | 1 part |
| Methyl ethyl ketone/cyclohexanone (8/2 by weight) | 250 parts |

The hematite, carbon black, and vinyl chloride copolymer were kneaded together with 130 parts (out of 250 parts) of the 8:2 mixed solvent of methyl ethyl ketone and cyclohexanone in a kneader. The rest of the above components were mixed therein, and the mixture was dispersed in a sand grinder together with zirconia beads of 1 mm in diameter. Ten parts of polyisocyanate and 30 parts of cyclohexanone were added thereto. The resulting dispersion was filtered through a filter having an average opening size of 1 μm to prepare coating non-magnetic coating composition 1.

Formulation 2:

| | |
|---|---|
| Acicular hematite (non-magnetic powder shown in Table 4) | 80 parts |
| Carbon black (Conductex SC-U) | 20 parts |
| Vinyl chloride copolymer (MR110 from Zeon Corp.) | 12 parts |
| Polyurethane resin (UR8200 from Toyobo) | 5 parts |
| Stearic acid | 3 parts |
| Butyl stearate | 10 parts |
| Butoxyethyl stearate | 5 parts |
| Isohexadecyl stearate | 3 parts |
| Methyl ethyl ketone/cyclohexanone (8/2 by weight) | 250 parts |

The hematite, carbon black, and vinyl chloride copolymer were kneaded together with 130 parts (out of 250 parts) of the 8:2 mixed solvent of methyl ethyl ketone and cyclohexanone in a kneader. The rest of the above components were mixed therein, and the mixture was dispersed in a sand grinder together with zirconia beads of 1 mm in diameter. Ten parts of polyisocyanate and 30 parts of cyclohexanone were added thereto. The resulting dispersion was filtered through a filter having an average opening size of 1 μm to prepare non-magnetic coating composition 2.

Formulation 3:

| | |
|---|---|
| Titanium dioxide (non-magnetic powder) (crystal form: rutile; | 80 parts |
| average particle size: 35 nm; S_{BET}: 40 m²/g; pH: 7; TiO₂ | |
| content: 90% or more; DBP oil absorption: 27 to | |
| 38 ml/100 g; surface coating layer: Al₂O₃ (8%)) | |
| Carbon black (Conductex SC-U) | 20 parts |
| Vinyl chloride copolymer (MR110 from Zeon Corp.) | 12 parts |
| Polyurethane resin (UR8200 from Toyobo) | 5 parts |
| Stearic acid | 3 parts |
| Butyl stearate | 1 part |
| Butoxyethyl stearate | 1 part |
| Isohexadecyl stearate | 1 part |
| Methyl ethyl ketone/cyclohexanone (8/2 by weight) | 250 parts |

The titanium dioxide, carbon black, and vinyl chloride copolymer were kneaded together with 130 parts (out of 250 parts) of the 8:2 mixed solvent of methyl ethyl ketone and cyclohexanone in a kneader. The rest of the above components were mixed therein, and the mixture was dispersed in a sand grinder together with zirconia beads of 1 mm in diameter. Ten parts of polyisocyanate and 30 parts of cyclohexanone were added thereto. The resulting dispersion was filtered through a filter having an average opening size of 1 μm to prepare non-magnetic coating composition 3.

Formulation 4:

| | |
|---|---|
| Titanium dioxide (non-magnetic powder) (crystal form: rutile; | 80 parts |
| average particle size: 35 nm; S_{BET}: 40 m²/g; pH: 7; TiO₂ | |
| content: 90% or more; DBP oil absorption: 27 to | |
| 38 ml/100 g; surface coating layer: Al₂O₃ (8%)) | |
| Carbon black (Conductex SC-U) | 20 parts |
| Vinyl chloride copolymer (MR110 from Zeon Corp.) | 12 parts |
| Polyurethane resin (UR8200 from Toyobo) | 5 parts |
| Stearic acid | 3 parts |
| Butyl stearate | 10 parts |
| Butoxyethyl stearate | 5 parts |
| Isohexadecyl stearate | 3 parts |
| Methyl ethyl ketone/cyclohexanone (8/2 by weight) | 250 parts |

The titanium dioxide, carbon black, and vinyl chloride copolymer were kneaded together with 130 parts (out of 250 parts) of the 8:2 mixed solvent of methyl ethyl ketone and cyclohexanone in a kneader. The rest of the above components were mixed therein, and the mixture was dispersed in a sand grinder together with zirconia beads of 1 mm in diameter. Ten parts of polyisocyanate and 30 parts of cyclohexanone were added thereto. The resulting dispersion was filtered through a filter having an average opening size of 1 μm to prepare non-magnetic coating composition 4.

### Examples 1 to 14 and Comparative Examples 1 to 5

The non-magnetic coating composition 1 or 3 was applied to a 6.5 μm thick polyethylene terephthalate base film to a dry thickness indicated in Table 2 and dried to form a non-magnetic layer. Magnetic coating composition 1 for magnetic layer was applied thereon by means of a coating apparatus having a front slit and a rear slit. The coating composition was fed through the front slit to a wet thickness of 250 nm, and the excess of the composition applied was sucked up through the rear slit to give a dry coating thickness of 80 nm. While the magnetic layer was wet, it was longitudinally oriented by passing through a rare earth magnetic (surface magnetic flux density: 500 mT) and then a solenoid magnet (magnetic flux density: 500 mT). While passing through the solenoid, the coating layer was dried to such an extent that the magnetic powder might not be deoriented. The coated film was further dried in a drying zone and wound. A backcoating layer mainly comprising carbon black and a binder was applied to the opposite side of the base film and dried. The coated film was passed through a 7-roll calender composed of metal rolls at a roll temperature of 90° C. to obtain a magnetic recording medium in web form, which was slit into 8 mm wide video tapes.

The resulting magnetic tape was measured for electromagnetic characteristics, magnetic characteristics, surface roughness, and constituent layer thickness in accordance with the following methods. The results obtained are shown in Table 2.

Separately, the non-magnetic coating composition 1 or 3 was applied to a 6.5 μm thick polyethylene terephthalate base film to a dry thickness indicated in Table 2 and dried to prepare a sample having the non-magnetic layer. The pore characteristics and surface properties of the non-magnetic layer were evaluated as follows. The results are also shown in Table 2.

1) Electromagnetic Characteristics

The magnetic tape was run on an 8 mm deck for data recording equipped with an MIG head (head gap: 0.2 μm; track width: 17 μm; saturation magnetic flux density: 1.5 T; azimuth angle: 20°) and an MR head for reproducing (SAL bias; MR element: Fe—Ni; track width: 6 μm; gap length: 0.15 μm; azimuth angle: 20°). An optimum recording current was decided from the input/output characteristics in recording ½ Tb (λ=0.35 μm) signals at a relative tape running speed of 10.2 m/sec (with respect to the MIG head). Signals were recorded at the optimum current with the MIG head and reproduced with the MR head. The C/N was defined to be a ratio covering from reproduced carrier peak to demagnetization noise. The resolution band width of the spectral analyzer was set at 100 kHz. The output and the C/N were relatively expressed taking the results of Comparative Example 4 as a standard.

2) Magnetic Characteristics

Magnetic characteristics were measured with a vibrating sample magnetometer in an applied magnetic field of 796 kA/m.

3) Thickness of Magnetic and Non-Magnetic Layers

A slice with a thickness of about 0.1 μm was cut across the magnetic tape with a diamond knife. The cut area of the slice was photographed under a TEM at a magnification of 50,000 times. The micrograph was printed to A4 to A5 size to give a photograph of 200,000 magnification. The interface between the magnetic layer and the non-magnetic layer in the print, which was visually defined by the difference in shape between ferromagnetic powder of the magnetic layer and the non-magnetic powder of the non-magnetic layer, was traced in black. The surface of the magnetic layer and the surface of the base film were also traced in black. The distances between the black lines were measured on an image processor IBS2 (FROM Zeiss). When the photograph was 21 cm long in the direction perpendicular to the sample's thickness direction, the measurement was made at 85 to 300 points per adjacent two lines. The mean values of the data obtained were taken as the magnetic layer thickness and the non-magnetic layer thickness.

4) Surface Roughness of Magnetic and Non-Magnetic Layers

The surface profile of a 250 μm side square of a sample was measured with a three-dimensional profilometer TOPO-3D, supplied by Wyko. In computing the measured values, corrections such as tilt correction, spherical correction and cylindrical correction, were made in accordance with JIS B601. The mean surface roughness Sa was taken as a measure of surface roughness. The surface roughness of the non-magnetic layer was measured using the above-described coated sample having only the non-magnetic layer on the base film.

5) Specific Surface Area (S_{BET}), Pore Volume, Mean Pore Radius, and D10 and D90 in Adsorption and Desorption of Non-Magnetic Layer

A specimen with an area of 300 to 600 cm² was cut out of the coated sample. The weight and thickness of the specimen were measured. Nitrogen adsorption/desorption isotherms were measured with an automatic gas adsorption analyzer AUTOSORB-1 from Quanta Chrome Inst. Co. at liquid-nitrogen temperature. Prior to the measurements, all the specimens were degassed at room temperature for 5 hours. The specific surface area per unit weight was calculated from the adsorption/desorption data according to multipoint BET method. The nitrogen adsorption/desorption isotherm was analyzed by the BJH method to obtain the pore size distribution, from which the pore volume per unit weight and the mean pore radius were calculated. D10 and D90 (the pore radii at which the cumulative pore volume reaches 10% and 90%, respectively, of the total pore volume) were calculated from the cumulative curve of the pore distribution. The volume of the non-magnetic layer was obtained from the area and thickness of the specimen (the support has no pores), and the specific surface area and the pore volume per unit weight were converted to those per unit volume (1 ml).

TABLE 2

| | | | | | | | | | | | Characteristics of Non-magnetic Layer | | | | | | | |
|---|---|---|---|---|---|---|---|---|---|---|---|---|---|---|---|---|---|---|
| | Non- | | | | | | | | | | | | | D10 | D90 | D10 | D90 | |
| | mag- | | Lower | Mag- | Characteristics of | | | Sa of | | | | | Mean | in | in | in | in | |
| | netic | Non- | Layer | netic | Magnetic Layer | | | Mag- | | | | | Pore | Ad- | Ad- | De- | De- | |
| | Coating | mag- | thick- | Coating | Hc | | Br · t | netic | Out- | | S_{BET} | Pore | Ra- | sorp- | sorp- | sorp- | sorp- | |
| | Compo- | netic | ness | Compo- | (kA/ | | (mT · | Layer | put | S/N | (m²/ | Vol. | dius | tion | tion | tion | tion | Sa |
| | sition | Powder | (μm) | sition | m) | SQ | μm) | (nm) | (dB) | (dB) | ml) | (ml) | (nm) | (nm) | (nm) | (nm) | (nm) | (nm) |
| Example | | | | | | | | | | | | | | | | | | |
| No. | | | | | | | | | | | | | | | | | | |
| 1 | 1 | Prepn. | 2.0 | 1 | 201 | 0.866 | 29.8 | 2.3 | 2.5 | 3.5 | 38 | 0.23 | 12 | 8 | 22 | 6.3 | 9.8 | 4.6 |
| | | Ex. 2 | | | | | | | | | | | | | | | | |
| 2 | 1 | Prepn. | 2.0 | 1 | 199 | 0.852 | 29.3 | 2.5 | 2.0 | 2.9 | 22 | 0.17 | 15 | 11 | 25 | 7.3 | 11 | 5.2 |
| | | Ex. 3 | | | | | | | | | | | | | | | | |
| 3 | 1 | Prepn. | 2.0 | 1 | 200 | 0.858 | 29.5 | 2.4 | 2.1 | 3.3 | 28 | 0.21 | 15 | 10 | 21 | 6.4 | 9 | 5.4 |
| | | Ex. 5 | | | | | | | | | | | | | | | | |
| 4 | 1 | Prepn. | 2.0 | 1 | 200.5 | 0.862 | 29.6 | 2.4 | 2.2 | 3.5 | 70 | 0.28 | 8 | 4.5 | 12 | 4.1 | 5.8 | 5.3 |
| | | Ex. 6 | | | | | | | | | | | | | | | | |
| 5 | 1 | Prepn. | 2.0 | 1 | 199.5 | 0.855 | 29.4 | 2.5 | 1.9 | 3.7 | 29 | 0.19 | 13.5 | 8.4 | 16 | 5.6 | 7 | 4.8 |
| | | Ex. 7 | | | | | | | | | | | | | | | | |
| 6 | 1 | Prepn. | 1.0 | 1 | 201.6 | 0.867 | 29.8 | 2.5 | 2.0 | 3.1 | 55 | 0.35 | 12.5 | 7.5 | 22 | 6.3 | 12 | 4.5 |
| | | Ex. 2 | | | | | | | | | | | | | | | | |
| 7 | 1 | Prepn. | 1.0 | 1 | 199.2 | 0.854 | 29.3 | 2.6 | 1.8 | 2.8 | 52 | 0.33 | 13 | 7.1 | 23 | 6.1 | 13 | 5 |
| | | Ex. 3 | | | | | | | | | | | | | | | | |
| 8 | 1 | Prepn. | 1.0 | 1 | 200.4 | 0.861 | 29.6 | 2.5 | 1.9 | 2.9 | 62 | 0.35 | 14 | 9 | 22 | 6.2 | 10.5 | 5.1 |
| | | Ex. 5 | | | | | | | | | | | | | | | | |
| 9 | 1 | Prepn. | 1.0 | 1 | 200.5 | 0.863 | 29.7 | 2.6 | 1.9 | 3.0 | 108 | 0.36 | 7 | 4 | 12 | 3.9 | 6.9 | 5.2 |
| | | Ex. 6 | | | | | | | | | | | | | | | | |
| 10 | 1 | Prepn. | 1.0 | 1 | 199.8 | 0.856 | 29.4 | 2.7 | 1.7 | 3.0 | 73 | 0.36 | 11.5 | 7.8 | 16 | 5.3 | 8.5 | 4.8 |
| | | Ex. 7 | | | | | | | | | | | | | | | | |
| 11 | 1 | Prepn. | 2.5 | 1 | 200.3 | 0.861 | 29.6 | 2.5 | 2.0 | 3.3 | 40.5 | 0.26 | 13 | 8 | 18 | 5.6 | 8.3 | 4.7 |
| | | Ex. 4 | | | | | | | | | | | | | | | | |
| 12 | 1 | Prepn. | 2.0 | 1 | 200.4 | 0.863 | 29.7 | 2.3 | 2.3 | 3.5 | 42 | 0.27 | 13 | 8 | 17 | 5.6 | 8.3 | 4.7 |
| | | Ex. 4 | | | | | | | | | | | | | | | | |
| 13 | 1 | Prepn. | 1.0 | 1 | 200.7 | 0.866 | 29.8 | 2.2 | 2.6 | 3.8 | 85 | 0.38 | 12 | 7.5 | 17 | 5.3 | 9.4 | 4.5 |
| | | Ex. 4 | | | | | | | | | | | | | | | | |
| 14 | 1 | Prepn. | 0.6 | 1 | 200.9 | 0.868 | 29.6 | 2.5 | 2.1 | 3.4 | 80 | 0.39 | 11 | 7.5 | 16.5 | 5.1 | 9.5 | 4.5 |
| | | Ex. 4 | | | | | | | | | | | | | | | | |
| Compa. | | | | | | | | | | | | | | | | | | |
| Example | | | | | | | | | | | | | | | | | | |
| No. | | | | | | | | | | | | | | | | | | |
| 1 | 1 | Prepn. | 2.7 | 1 | 200.8 | 0.867 | 29.8 | 3.1 | 0.6 | 0.7 | 39 | 0.25 | 13.5 | 8.2 | 18.5 | 5.6 | 8.2 | 5.2 |
| | | Ex. 4 | | | | | | | | | | | | | | | | |
| 2 | 1 | Prepn. | 2.0 | 1 | 198.2 | 0.846 | 29.1 | 3.2 | 0.5 | 0.8 | 18 | 0.14 | 22 | 14 | 33 | 11 | 19 | 5.7 |
| | | Ex. 1 | | | | | | | | | | | | | | | | |
| 3 | 1 | Prepn. | 1.0 | 1 | 198 | 0.847 | 29.1 | 3.4 | 0.1 | 0.0 | 33 | 0.33 | 24 | 13 | 34 | 10.5 | 21 | 5.7 |
| | | Ex. 1 | | | | | | | | | | | | | | | | |
| 4 | 3 | TiO₂ | 2.0 | 1 | 197.2 | 0.838 | 28.8 | 3.5 | 0.0 | 0.0 | 10 | 0.12 | 18 | 7 | 21 | 5.6 | 14 | 6.2 |
| 5 | 3 | TiO₂ | 1.0 | 1 | 197.1 | 0.839 | 28.9 | 3.6 | −0.5 | −0.6 | 18 | 0.14 | 17 | 6.5 | 21 | 5.2 | 15 | 6.2 |

It is seen from Table 2 that the magnetic recording medium according to the present invention has a small surface roughness and exhibits high output and high S/N and are therefore expected to achieve high density recording.

### Examples 15 to 18 and Comparative Example 6

The non-magnetic coating composition 1 containing the hematite of Preparation Example 4 was applied to a 6.5 μm thick polyethylene terephthalate base film to a dry thickness of 1.5 μm and dried to form a non-magnetic layer. Magnetic coating composition 1 was applied to the non-magnetic layer by means of a coating apparatus having a front slit and a rear slit. The coating composition was fed through the front slit to a wet thickness of 250 nm, and the excess of the composition applied was sucked up through the rear slit to give the dry coating thickness shown in Table 3 below. The coated film was further treated in the same manner as in the foregoing Examples to produce magnetic recording tapes. The resulting tapes were evaluated in the same manner as in the foregoing Examples. The results obtained are shown in Table 3. With respect to the characteristics of the non-magnetic layer, only those of Example 15 are presented as representative data since the non-magnetic layers of all the tapes prepared had the same formulation.

TABLE 3

| | | | | | | | | | | | Characteristics of Non-magnetic Layer | | | | | | | |
|---|---|---|---|---|---|---|---|---|---|---|---|---|---|---|---|---|---|---|
| | Non- | | | Mag- | | | | | | | | | | D10 | D90 | D10 | D90 | |
| | mag- | Lower | Mag- | netic | Characteristics of | | | Sa of | | | | | | in | in | in | in | |
| | netic | Layer | netic | Layer | Magnetic Layer | | | Mag- | | | | | Mean | Ad- | Ad- | De- | De- | |
| Exam- | Coating | thick- | Coating | Thick- | Hc | | Br · t | netic | Out- | | S_{BET} | Pore | Pore | sorp- | sorp- | sorp- | sorp- | |
| ple | Compo- | ness | Compo- | ness | (kA/ | | (mT · | Layer | put | S/N | (m²/ | Vol. | Radius | tion | tion | tion | tion | Sa |
| No. | sition | (μm) | sition | (nm) | m) | SQ | μm) | (nm) | (dB) | (dB) | ml) | (ml) | (nm) | (nm) | (nm) | (nm) | (nm) | (nm) |
| 15 | 1 | 1.5 | 1 | 45 | 197 | 0.851 | 29.1 | 2.5 | 2.0 | 2.5 | 41 | 0.29 | 13 | 8 | 17 | 5.5 | 8.4 | 4.5 |
| 16 | 1 | 1.5 | 1 | 80 | 201.5 | 0.864 | 29.6 | 2.3 | 2.7 | 3.5 | | | | | | | | |
| 17 | 1 | 1.5 | 1 | 120 | 201 | 0.862 | 29.5 | 2.3 | 2.6 | 3.4 | | | | | | | | |
| 18 | 1 | 1.5 | 1 | 150 | 201 | 0.861 | 29.5 | 2.6 | 2.2 | 3.1 | | | | | | | | |
| Comp. | 1 | 1.5 | 1 | 180 | 201 | 0.855 | 29.3 | 3.2 | 0.3 | 0.5 | | | | | | | | |
| Ex. 6 | | | | | | | | | | | | | | | | | | |

As is seen from Table 3, the magnetic recording medium according to the present invention has a small surface roughness and exhibits high output and high S/N and are therefore expected to achieve high density recording.

### Examples 19 to 24 and Comparative Examples 7 and 8

The non-magnetic coating composition 2 or 4 was applied to a 68 μm thick polyethylene terephthalate base film to a dry thickness of 1.8 μm and dried to form a non-magnetic layer. Magnetic coating composition 2 was applied thereon to a wet thickness of 250 nm, and the excess of the composition applied was scraped with a blade to give a dry coating thickness of 90 nm. While the magnetic layer was wet, it was oriented at random by passing through an alternating magnetic field generator (24 kA/m at a frequency of 50 Hz and 12 kA/m at a frequency of 50 Hz). As a result, an orientation ratio of at least 98% was obtained.

The same magnetic coating composition was applied to the opposite side of the base film, oriented, and dried in the same manner as described above. The both-sided film was passed through a 7-roll calender at a roll temperature of 90° C. and a linear pressure of 300 kg/cm and punched to disks of 3.7 inch diameter. The disks were heat treated at 70° C. for 24 hours to accelerate curing of the coating. The coating surfaces were burnished with abrasive tape to scrape off the projections. The disk was encased between upper and lower shells for a 3.7 inch IOMEGa ZIP disk cartridge with a liner and assembled with other necessary fittings to produce a 3.7 inch floppy disk. The magnetic characteristics of the floppy disk, the surface roughness of the magnetic layer, and the characteristics of the non-magnetic layer were measured in the same manner as in the foregoing Examples. Further, the output and S/N of the floppy disk were measured as follows.

Evaluation of Floppy Disk:

The floppy disk was recorded at a linear recording density of 144 kbpi and a track density of 144 tpi. A product of the linear recording density and the track density gives an areal recording density. The output and S/N were expressed relatively taking the results of Comparative Example 8 as a standard. In the measurement of error rates, the disk was written at the above-specified linear recording density in (2,7) RLL modulation code.

TABLE 4

| | | | | | | | | | | | Characteristics of Non-magnetic Layer | | | | | | | |
|---|---|---|---|---|---|---|---|---|---|---|---|---|---|---|---|---|---|---|
| | Non- | | | | | | | | | | | | | D10 | D90 | D10 | D90 | |
| | mag- | | Lower | Mag- | Characteristics of | | | Sa of | | | | | Mean | in | in | in | in | |
| | netic | Non- | Layer | netic | Magnetic Layer | | | Mag- | | | | | Pore | Ad- | Ad- | De- | De- | |
| | Coating | mag- | thick- | Coating | Hc | | Br · t | netic | Out- | | S_{BET} | Pore | Ra- | sorp- | sorp- | sorp- | sorp- | |
| Example | Compo- | netic | ness | Compo- | (kA/ | | (mT · | Layer | put | S/N | (m²/ | Vol. | dius | tion | tion | tion | tion | Sa |
| No. | sition | Powder | (μm) | sition | m) | SQ | μm) | (nm) | (dB) | (dB) | ml) | (ml) | (nm) | (nm) | (nm) | (nm) | (nm) | (nm) |
| 19 | 2 | Prepn. | 1.8 | 2 | 173.3 | 0.575 | 7.8 | 2.2 | 1.8 | 2.5 | 38.3 | 0.22 | 12.2 | 8 | 22.1 | 6.3 | 9.8 | 4.5 |
| | | Ex. 2 | | | | | | | | | | | | | | | | |
| 20 | 2 | Prepn. | 1.8 | 2 | 173.2 | 0.574 | 7.7 | 2.5 | 1.6 | 2.4 | 22.5 | 0.17 | 15.1 | 11 | 25 | 7.3 | 11 | 5.2 |
| | | Ex. 3 | | | | | | | | | | | | | | | | |
| 21 | 2 | Prepn. | 1.8 | 2 | 173.2 | 0.575 | 7.8 | 2.2 | 2.1 | 2.9 | 42.5 | 0.26 | 13.2 | 8 | 17 | 6.4 | 9 | 4.6 |
| | | Ex. 4 | | | | | | | | | | | | | | | | |
| 22 | 2 | Prepn. | 1.8 | 2 | 173.4 | 0.575 | 7.8 | 2.3 | 1.9 | 2.6 | 28.3 | 0.21 | 15.1 | 10 | 21 | 4.1 | 5.8 | 5.3 |
| | | Ex. 5 | | | | | | | | | | | | | | | | |
| 23 | 2 | Prepn. | 1.8 | 2 | 173.2 | 0.574 | 7.7 | 2.4 | 1.8 | 2.7 | 71.1 | 0.27 | 8.1 | 4.5 | 12 | 5.6 | 7 | 5.3 |
| | | Ex. 6 | | | | | | | | | | | | | | | | |
| 24 | 2 | Prepn. | 1.8 | 2 | 173.3 | 0.576 | 7.8 | 2.5 | 1.7 | 2.5 | 29.8 | 0.18 | 13.3 | 8.4 | 16 | 6.3 | 12 | 4.8 |
| | | Ex. 7 | | | | | | | | | | | | | | | | |
| Comp. 7 | 2 | Prepn. | 1.8 | 2 | 173.1 | 0.568 | 7.7 | 3.2 | 0.6 | 0.5 | 18 | 0.24 | 22.1 | 14 | 33 | 6.1 | 13 | 5.8 |
| | | Ex. 1 | | | | | | | | | | | | | | | | |
| Comp. 8 | 4 | TiO₂ | 1.8 | 2 | 173.1 | 0.567 | 7.7 | 3.5 | 0.0 | 0.0 | 10 | 0.13 | 17 | 7 | 21 | 6.2 | 10.5 | 6.2 |

As can be seen from the results in Table 4, the flexible disks of the present invention have a small surface roughness and exhibit high output and high S/N. Accordingly, they are capable of high-density recording with low error rates.

This application is based on Japanese Patent application JP2003-270381, filed Jul. 2, 2003, the entire content of which is hereby incorporated by reference, the same as if set forth at length.

1. A process for producing a magnetic recording medium comprising the steps of applying a coating composition containing non-magnetic powder and a binder on a support to form a non-magnetic layer having a thickness of 0.5 to 2.5 μm, a specific surface area of 20 to 120 m²/ml, a pore volume of 0.15 to 0.40 ml/ml, and a mean pore radius of 3 to 16 nm and applying a coating composition containing ferromagnetic powder and a binder on the non-magnetic layer to form a magnetic layer having a thickness of 25 to 150 nm.

2. The process according to claim 1, wherein the ferromagnetic powder is a ferromagnetic metal powder having an average long axis length of 30 to 65 nm, a coefficient of long axis length variation of 0 to 35%, an average aspect ratio of 3.5 to 7.5, a coercive force of 143 to 223 kA/m, a saturation magnetization of 85 to 125 A.m²/kg, and a specific surface area of 45 to 120 m²/g.

3. The process according to claim 1, wherein the ferromagnetic powder is a hexagonal ferrite powder having an average diameter of 15 to 35 nm, a coefficient of diameter or thickness variation of 0 to 30%, an average aspect ratio of 1.5 to 4.5, a coercive force of 120 to 320 kA/m, a saturation magnetization of 40 to 55 A.m²/kg, and a specific surface area of 40 to 100 m²/g.

4. The process according to claim 1, wherein the non-magnetic powder contains at least one of titanium dioxide, zinc oxide, alpha iron oxide, goethite, tin oxide, and barium sulfate.

5. The process according to claim 1, wherein the non-magnetic powder contains at least one of titanium dioxide, alpha iron oxide, and goethite.

6. The process according to claim 1, wherein the non-magnetic layer has a thickness of 0.6 to 2.5 μm.

7. The process according to claim 1, wherein the non-magnetic layer has a specific surface area of 20 to 110 m²/ml.

8. The process according to claim 1, wherein the non-magnetic layer has a pore volume of 0.16 to 0.39 ml/ml.

9. The process according to claim 1, wherein the non-magnetic layer has a mean pore radius of 4 to 16 nm.

10. The process according to claim 1, wherein the coating composition for forming the non-magnetic layer further contains a carbon black.

11. The process according to claim 1, wherein the magnetic layer has a thickness of 25 to 100 nm.
